(19) United States
(12) Patent Application Publication
(10) Pub. No.: US 2002/0184056 A1
(43) Pub. Date: Dec. 5, 2002

(54) Health promotion practitioner support apparatus and computer readable medium storing health promotion practitioner support program

(76) Inventors: Toshiaki Tsuboi, Yokohama-shi (JP); Kouhei Toriu, Nakano-ku (JP); Tomoshi Takada, Uji-shi (JP); Hiroshi Yoshikawa, Urayasu-shi (JP); Yumiko Nishimura, Stanford, CA (US); Yousuke Chikamoto, Fullerton, CA (US)

Correspondence Address: KENYON & KENYON, ONE BROADWAY, NEW YORK, NY, 10004, US

(21) Appl. No.: 09/870,147

(22) Filed: May 30, 2001

(51) Int. Cl. G06F 17/60

(52) U.S. Cl. 705/3

(57) ABSTRACT

A health promotion practitioner support apparatus is provided. The health promotion practitioner support apparatus includes a part storing scenarios which includes health promotion information and health promotion timing for each of levels of readiness for change; a part obtaining data on lifestyles and the level of readiness for change of a client; a part preparing a health promotion schedule of the client from the scenario and the data, and outputting the health promotion schedule; and a part outputting health promotion information for the client according to operation to the health promotion schedule.

### BACKGROUND OF THE INVENTION

1. Field of the Invention

The present invention generally relates to a technique for supporting health promotion for preventing diseases caused by lifestyles and for promoting and maintaining health. More particularly, the present invention relates to a technique to standardize health promotion provided by a health promotion practitioner after a medical examination such that follow-up health promotion can be provided to a client effectively and properly to improve lifestyles.

2. Description of the Related Art

As a conventional technique, a system which outputs an advice for improving a lifestyle on the basis of medical treatment data obtained by medical examination is known.

In addition, there is a system in which past examination data is stored so that the examination data is displayed in chronological order. Further, there is a system which allows a health promotion practitioner to take notes of the situation of health promotion.

However, since the system which outputs an advice for improving a lifestyle on the basis of medical examination only shows information for improving the lifestyle, there is a problem in that the system can not aid a person to improve the lifestyle continuously and concretely.

In addition, there is a problem in that, even if examination data is displayed in chronological order, a big difference is caused among health promotion methods due to discretion of health promotion practitioners.

Further, only taking notes of the situation of health promotion does not lead to supporting a client to improve a lifestyle continuously and concretely.

Generally, health promotion for improving lifestyles includes many things. Thus, it is difficult to create a database used for performing health promotion and there is a difference in health promotion methods according to ability difference between health promotion practitioners. Therefore, it is difficult to perform health promotion systematically and continuously. Accordingly, there is a problem in that it is difficult to perform health promotion for many people including healthy people.

### SUMMARY OF THE INVENTION

It is an object of the present invention to provide a technique to standardize a follow-up health promotion method provided by a health promotion practitioner after a medical examination and to aid the health promotion practitioner to perform continuous health promotion effectively.

The above object of the present invention is achieved by a health promotion practitioner support apparatus used for supporting health promotion for preventing diseases caused by lifestyles and for promoting and maintaining health, including:

a part storing scenarios which includes health promotion information and health promotion timing for each of levels of readiness for change;

a part obtaining data on lifestyles and the level of readiness for change of a client;

a part preparing a health promotion schedule of the client from the scenario and the data, and outputting the health promotion schedule; and

a part outputting health promotion information for the client according to operation to the health promotion schedule.

According to the present invention, since the health promotion schedule for each client is generated by using the standardized scenario including health promotion information and health promotion timing, difference of health promotion methods among health promotion practitioners is eliminated so that health promotion can be standardized. In addition, continuous health promotion can be provided according to the health promotion schedule. Further, since the health promotion can be performed according to the level of readiness for change, health promotion can be performed properly corresponding to each stage of readiness for change.

In the above-mentioned health promotion practitioner support apparatus, the part obtaining data may includes:

a part outputting information used for interviewing the client; and

a part receiving responses of the client.

In the above-mentioned health promotion practitioner support apparatus, the part outputting information used for interviewing the client may includes:

a part outputting question information for checking the level of readiness for change; and

a part determining the level of readiness for change according to a response to the question information and determining information to be output hereafter according to the level of readiness for change;

wherein the health promotion practitioner support apparatus determines the health promotion information according to responses of the client.

According to the above-mentioned invention, the health promotion practitioner can easily obtain data necessary for performing follow-up health promotion by interviewing a client according to information output by the health promotion practitioner support apparatus. In addition, the health promotion practitioner can explain diseases caused by lifestyles and perform health promotion in the interview.

In the above-mentioned health promotion practitioner support apparatus, the levels of readiness for change may include an unconcerned stage, a precontemplation stage, a contemplation stage and a preparation stage.

Accordingly, health promotion can be performed properly based on a theory of behavioral science.

In the above-mentioned health promotion practitioner support apparatus, the health promotion schedule may be displayed as a screen of a calendar format on a display part of the health promotion practitioner support apparatus or on a terminal which can access the health promotion practitioner support apparatus; and

a number of clients may be displayed in each day of the calendar format if the clients should receive health promotion on the day, and health promotion details are displayed for each of the clients by selecting the day.

According to the above-mentioned invention, the operator, that is, the health promotion practitioner can easily grasp clients for each day. In addition, health promotion can be performed easily. Therefore, performing continuous health promotion becomes possible.

In the above-mentioned health promotion practitioner support apparatus, data for forming the health promotion schedule may include histories of provided health promotion.

Accordingly, the health promotion practitioner can grasp past health promotion state which can be reflected to health promotion hereinafter.

The above-mentioned health promotion practitioner support apparatus may further includes:

a part storing plurality of kinds of health promotion information, the plurality of kinds of health promotion information including interview health promotion information, telephone health promotion information, and documents to be sent physically or by electronic mail; and

wherein the part outputting health promotion information outputs the health promotion information by means suitable for one of the kinds of health promotion information.

According to the above-mentioned invention, it becomes possible that health promotion information can be prepared beforehand and that various means can be used for performing follow-up health promotion for clients.

Further, the health promotion practitioner support apparatus may further includes:

a part obtaining results of medical examination; and

a part selecting clients for preventing a specific disease by using the results.

Accordingly, clients can be selected automatically by using the medical examination results.

### BRIEF DESCRIPTION OF THE DRAWINGS

Other objects, features and advantages of the present invention will become more apparent from the following detailed description when read in conjunction with the accompanying drawings, in which:

FIG. 1 shows a configuration of a health promotion practitioner support system according to an embodiment of the present invention;

FIG. 2 is a block diagram showing functions of a health promotion practitioner support server 101;

FIG. 3 shows a flowchart for preparing a scenario;

FIG. 4 shows an example of the scenario managed in a scenario storing part 7;

FIG. 5 shows a stage model of levels of readiness for change for health;

FIG. 6 is a health promotion flowchart (follow-up scenario) for stop smoking;

FIG. 7 shows a screen for editing the scenario;

FIG. 8 shows an example of examination data /health question data/medical examination results;

FIG. 9 shows an example of the data on daily lifestyles and readiness for change;

FIG. 10 shows an operation example (an example for smoking) of a navigation function by an interview support screen display part;

FIG. 11 shows an example of a screen for checking the level of readiness for change for stopping smoking;

FIG. 12 is an example of a screen for checking time period of stopping smoking and occasions of starting smoking;

FIG. 13 is an example of a screen for checking the reason why a client can not stop smoking;

FIG. 14 is an example of a screen for checking nicotine dependence;

FIG. 15 is an example of a screen for describing effects of smoking and the like;

FIG. 16 is an example of a screen for performing health promotion such as praising the client for planning stop of smoking and the like;

FIG. 17 is an example of a screen for giving advice;

FIG. 18 is an example of a screen for performing health promotion by describing usefulness of determining the day for stopping smoking and the like;

FIG. 19 is an example of a screen for performing health promotion by describing how to react when the client wants to smoke and the like;

FIG. 20 is a flowchart for generating the health promotion schedule for each client;

FIG. 21 shows an example of schedule data stored in a schedule storing part;

FIG. 22 shows a process flowchart from schedule unfolding to electronic male sending, material sending and support screen displaying;

FIG. 23 is an example of a screen of the health promotion schedule;

FIG. 24 is an example of a screen displaying detailed health promotion actions of a day which is clicked on the screen of the health promotion schedule;

FIG. 25 shows an example of contents of an electronic mail used for follow-up health promotion;

FIG. 26 shows an example of telephone health promotion screen;

FIG. 27 shows an example of a news letter.

### DETAILED DESCRIPTION OF THE PREFERRED EMBODIMENTS

In the following, an embodiment of the present invention will be described with reference to figures.

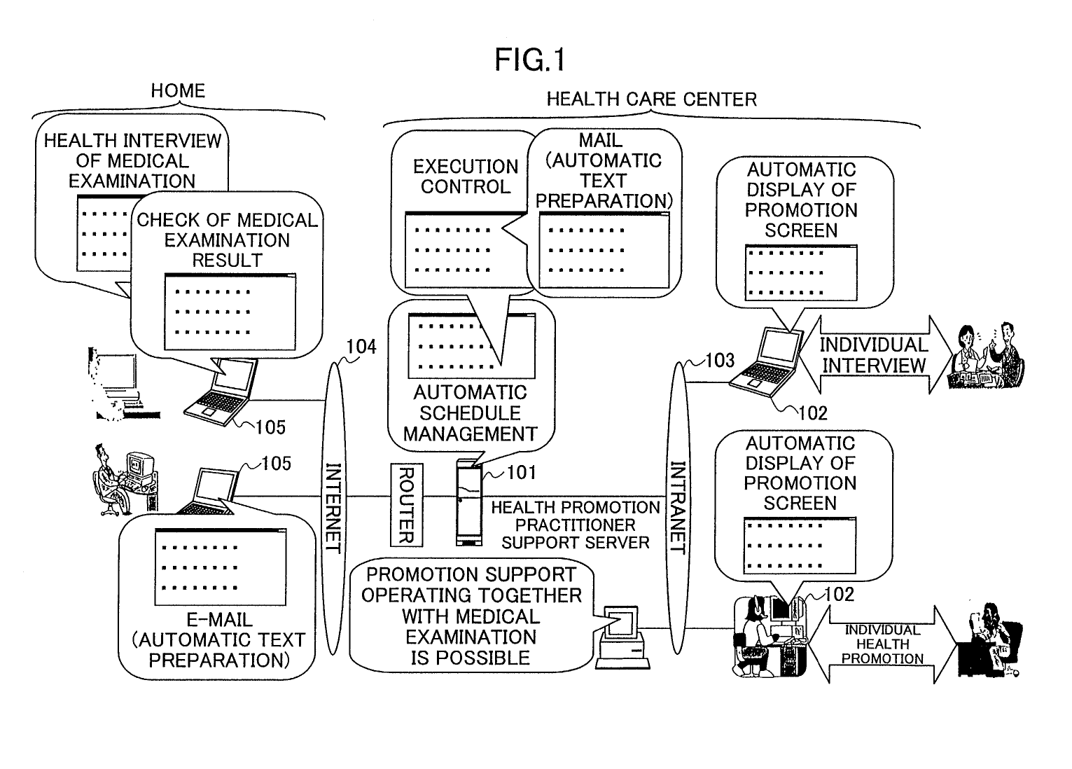

FIG. 1 shows a configuration of a health promotion practitioner support system according to the embodiment of the present invention.

The health promotion practitioner support system of the embodiment includes a health promotion practitioner support server 101 and terminals 102 of health promotion practitioners which are connected to an intranet 103 in a health care center. In addition, the health promotion practitioner support server 101 is connected to user terminals 105 which are in clients' houses and the like via the Internet 104.

In this system, the health promotion practitioner has an interview with a client by using a navigation function which displays interview support screens on the terminal 102. Then, the health promotion practitioner support server 101 draws up a health promotion schedule for the client on the basis of data obtained by the interview and medical examination. According to the schedule, the health promotion practitioner performs continuous health promotion for the client, for example, by sending an electronic mail to the terminal 105 of the client.

More particularly, details of standard health promotion are defined, as an scenario, for each of lifestyles (exercise, eating habit, smoking, stress and the like) and diseases (hypertension, hyperlipemia and the like), and, the scenario is stored in the health promotion practitioner support server 101.

The health promotion practitioner support server 101 receives, for each client, data on results of medical examination (examination data, health question data and the like) and data on daily lifestyles and levels of readiness for change for improving lifestyle which is obtained at the time of the interview. Then, the health promotion practitioner support server 101 generates a health promotion schedule for performing health promotion on the basis of the scenario so as to meet conditions for each client. In addition, the health promotion practitioner support server 101 supports health promotion practitioners to perform health promotion by sending electronic mails, printing materials and displaying interview support screens by using a calendar function (schedule management function). The details of each function shown in FIG. 1 will be shown in the following descriptions.

(System Configuration)

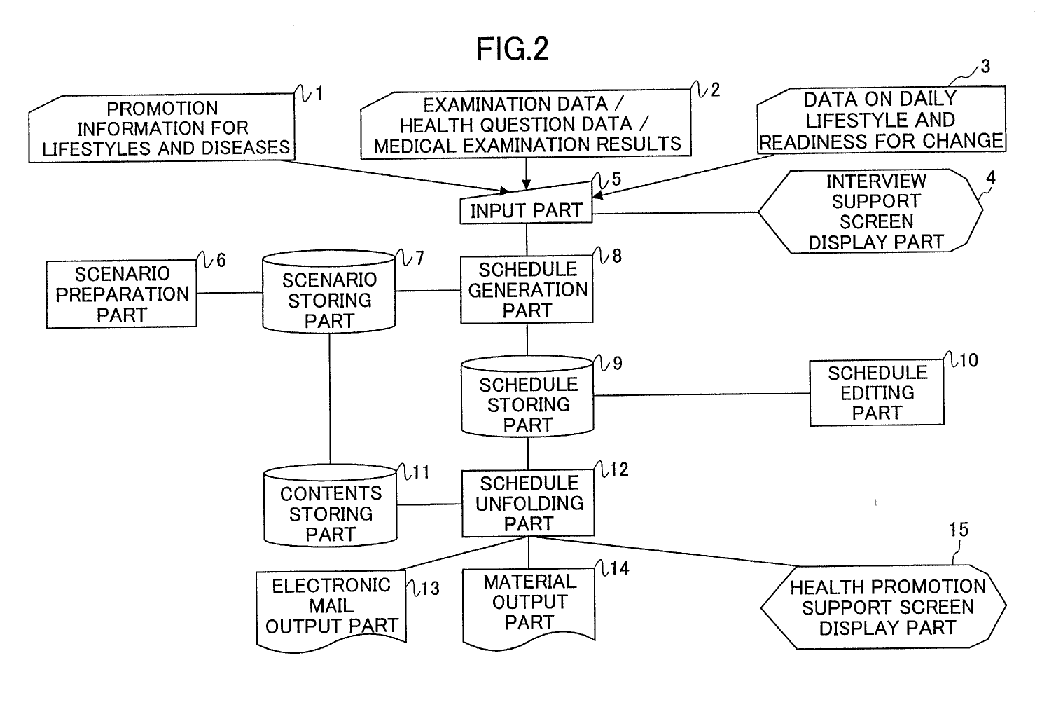

Next, functions of the health promotion practitioner support sever 101 will be described in detail with reference to FIG. 2 which is a block diagram of the functions.

The health promotion practitioner support server 101 includes an input part 5, an interview support screen display part 4, a scenario storing part 7, a scenario preparation part 6, a schedule generation part 8, a schedule storing part 9, a schedule editing part 10, a schedule unfolding part 12, a contents storing part 11, an electronic mail output part 13, a material output part 14, and a health promotion support screen display part 15.

Health promotion information 1 for lifestyles and diseases, and, examination data /health question data/medical examination results 2 obtained by medical examination are input from the input part 5 by the health promotion practitioner and the like. The interview support screen display part 4 displays, on the terminal 102, interview support screens according to responses of the client by using the navigation function. The health promotion practitioner inputs data 3 on daily lifestyles and readiness for change of the client into the terminal 102 while viewing the navigation screens. The data 3 is input to the input part 5.

The scenario preparation part 6 prepares standard health promotion details (the scenario) by using the health promotion information 1 for lifestyles and diseases and the like which are input by the health promotion practitioner. The scenario storing part 7 stores the scenario.

The schedule generation part 8 generates a health promotion schedule based on information in the scenario storing part 7 by using the examination data/health question data/medical examination results 2 and the data 3 on daily lifestyles and readiness for change for each client.

The schedule editing part 10 adds, deletes and modifies the health promotion schedule generated by the schedule generation part 8 as necessary. The schedule storing part 9 stores the edited health promotion schedule and history information on health promotion which has been performed.

The contents storing part 11 stores, beforehand, materials to be output and health promotion texts to be sent as the electronic mail. The schedule unfolding part 12 unfolds the health promotion schedule in the schedule storing part 9 on a calendar and displays it.

By selecting a day which is shown in the calendar displayed by the schedule unfolding part 12, the electronic mail output part 13 sends proper texts in the contents storing part 11 to the client as an electronic mail. The material output part 14 outputs materials managed by the contents storing part 11 for the client. The health promotion support screen display part 15 displays screens for supporting a telephone interview or an interview or the like.

The health promotion practitioner support server 101 can be configured by a computer which includes a CPU, a hard disk, an input device, an output device, a CD-ROM drive, a communication interface and the like. The above-mentioned functions can be realized by executing a program installed in the computer from a recording medium like a CD-ROM. In addition, in order to display screens on each terminal, the health promotion practitioner support server 101 includes a WWW function for example. In this case, each terminal can display health promotion practitioner support screens by using a WWW browser.

In the following, main functions of the above-mentioned system will be described in detail.

(Preparing a Scenario)

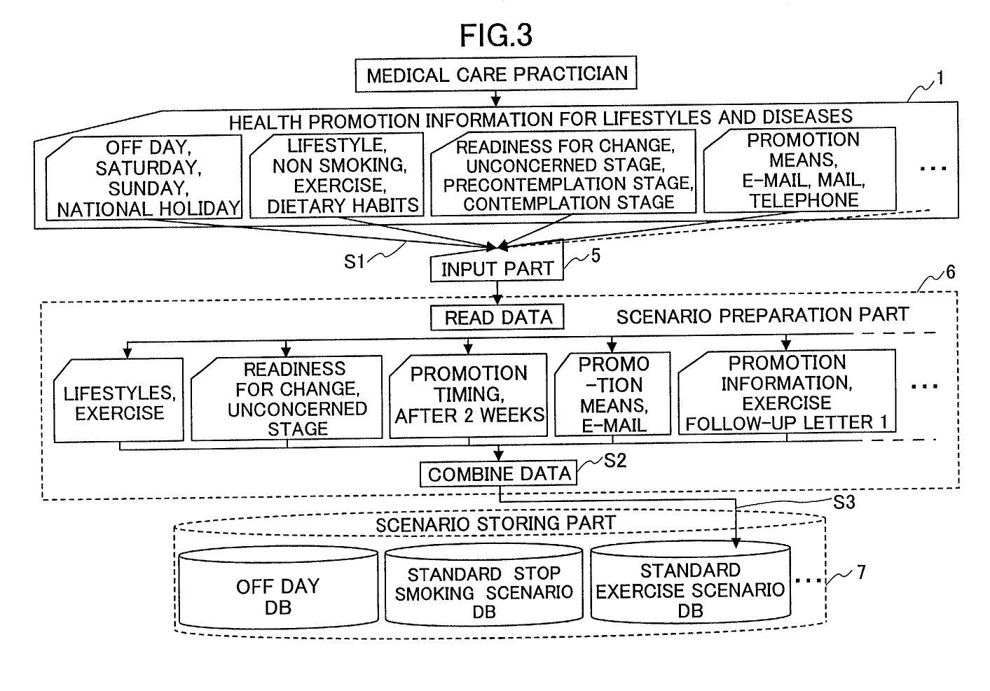

FIG. 3 shows a flowchart for preparing the scenario.

A health promotion practitioner inputs health promotion information 1 for lifestyles and diseases from the input part 5 in step 1. As shown in FIG. 3, off days, lifestyles, levels of readiness for change, health promotion means and the like are input as the health promotion information 1 for lifestyles and diseases. Next, the scenario preparation part 6 prepares a standard health promotion scenario in step 2. Then, the scenario is stored and managed in the scenario storing part 7 in step 3.

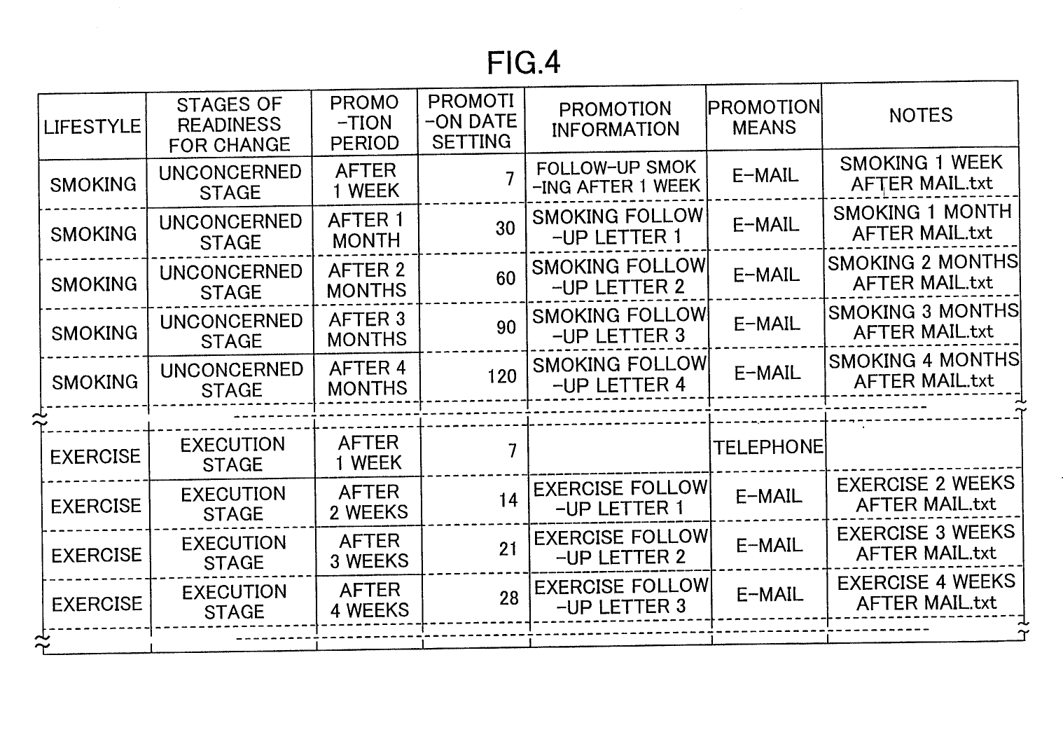

FIG. 4 shows an example of health promotion information, that is, the scenario, which is prepared by the scenario preparation part 6 and managed in the scenario storing part 7.

In FIG. 4, items in “lifestyle” are targets which should be improved by using the system of the present invention. The items may includes smoking, exercise and the like, for example.

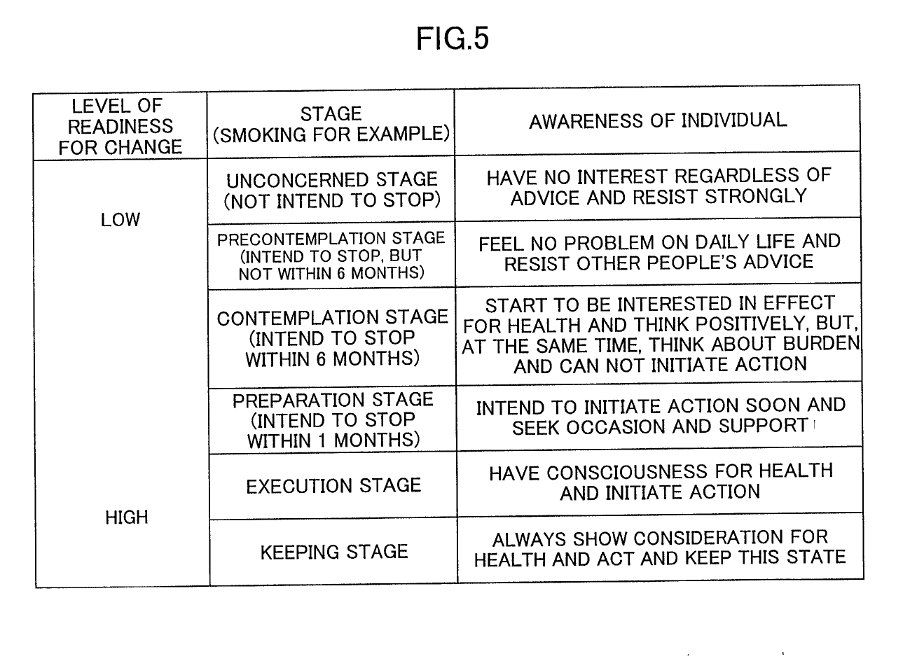

Health promotion details are determined according to stages of readiness for change of a client. As for the stages of readiness for change for health, a model based on a theory of behavioral science is known as shown in FIG. 5. The scenario of the present invention uses this model.

“promotion period” and “promotion date setting” are used for determining dates for performing health promotion for a client. “promotion information” indicates contents information used for health promotion. “promotion means” indicates means for performing health promotion actions. In “notes”, for example, file names of the contents information are shown. The description in “promotion information” becomes “Subject” of an electronic mail.

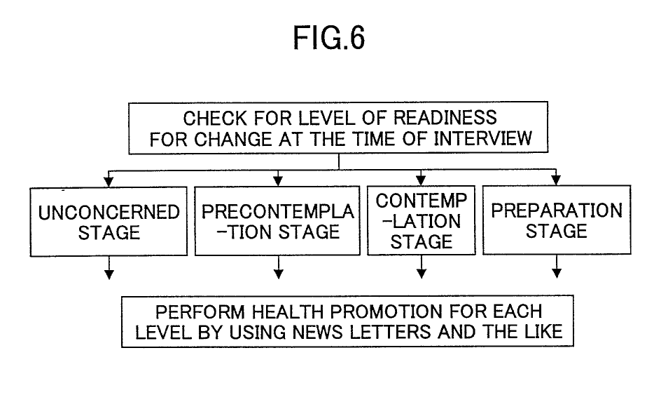

The scenario shown in FIG. 4 is prepared, for example, according to a health promotion flowchart shown in FIG. 6. The news letter shown in FIG. 6 is, for example, an electronic mail including texts which provides a client with evidence against thinking of the client obtained by the interview.

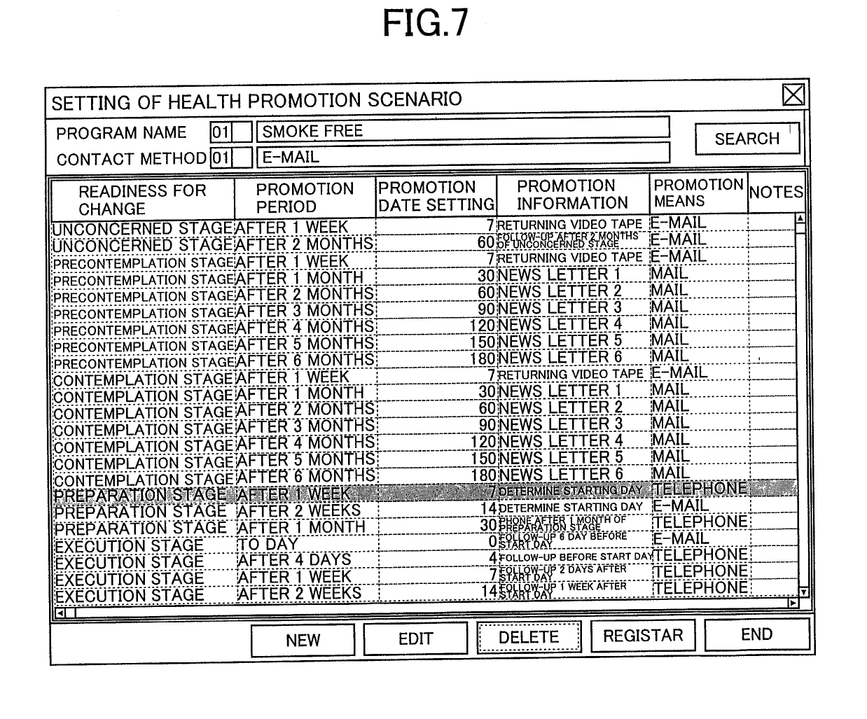

The scenario for each health promotion program such as for smoking, exercise and the like can be changed from a screen as shown in FIG. 7 by a health promotion practitioner as necessary.

(Obtaining Data on Lifestyles and Readiness for Change by an Interview)

The examination data/health question data/medical examination results 2 are input into the health promotion practitioner support server after medical examination ends.

Then, the health promotion practitioner inputs the data 3 on daily lifestyles and readiness for change according to responses of the client to the interview. The interview is performed according to instructions provided by screens displayed by the interview support screen display part 4.

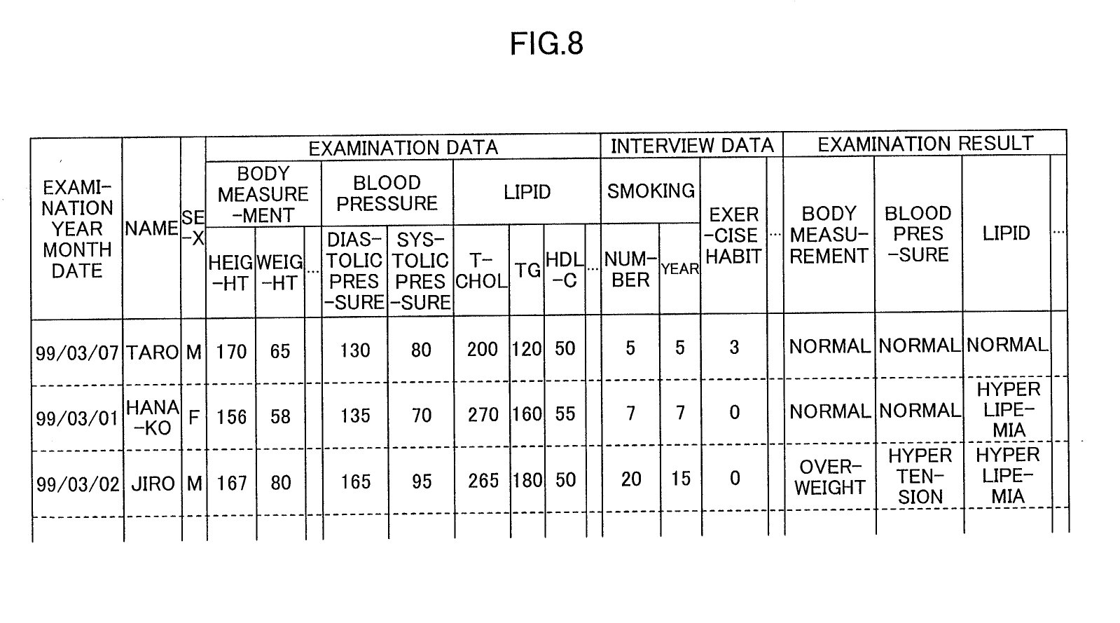

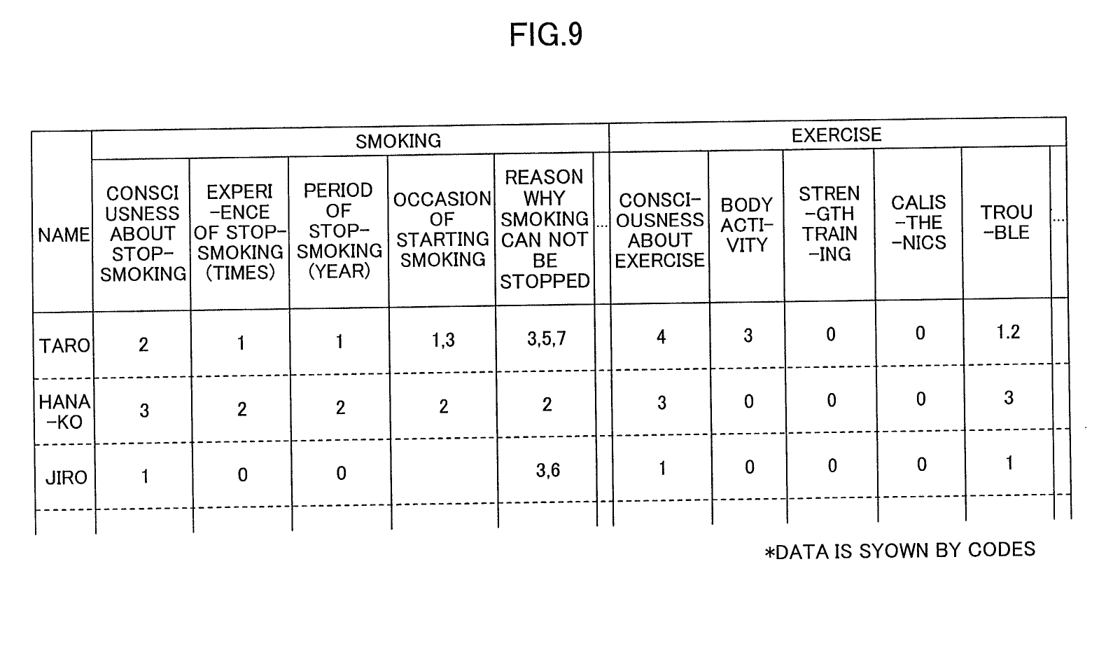

FIG. 8 shows an example of the examination data/health question data/medical examination results 2 and FIG. 9 shows an example of the data 3 on daily lifestyles and readiness for change. The examination data/health question data/medical examination results 2 can be downloaded from a system (such as a health care system) via a network.

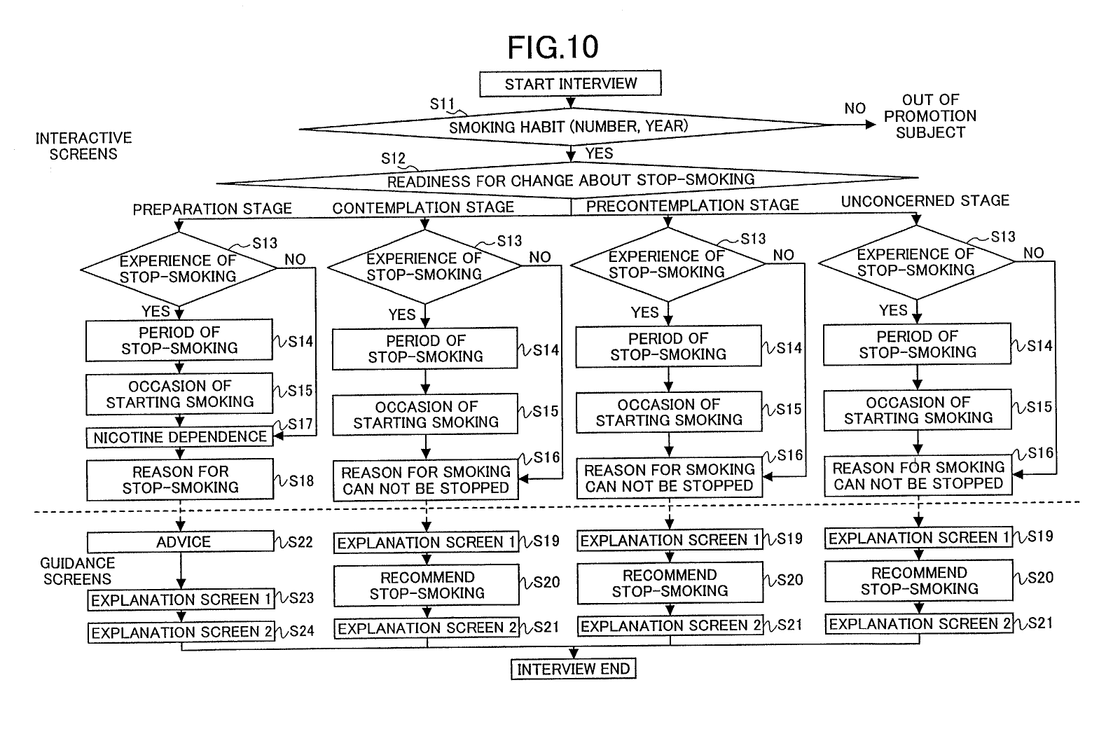

The interview support screen display part 4 includes a navigation function which displays screens adapted to the client according to responses of the client. FIG. 10 shows an operation example (an example for smoking) of the navigation function of the interview support screen display part 4. In the following, this function will be described in detail with reference to FIG. 10 and screen display examples. The health promotion practitioner interviews the client while viewing these screens.

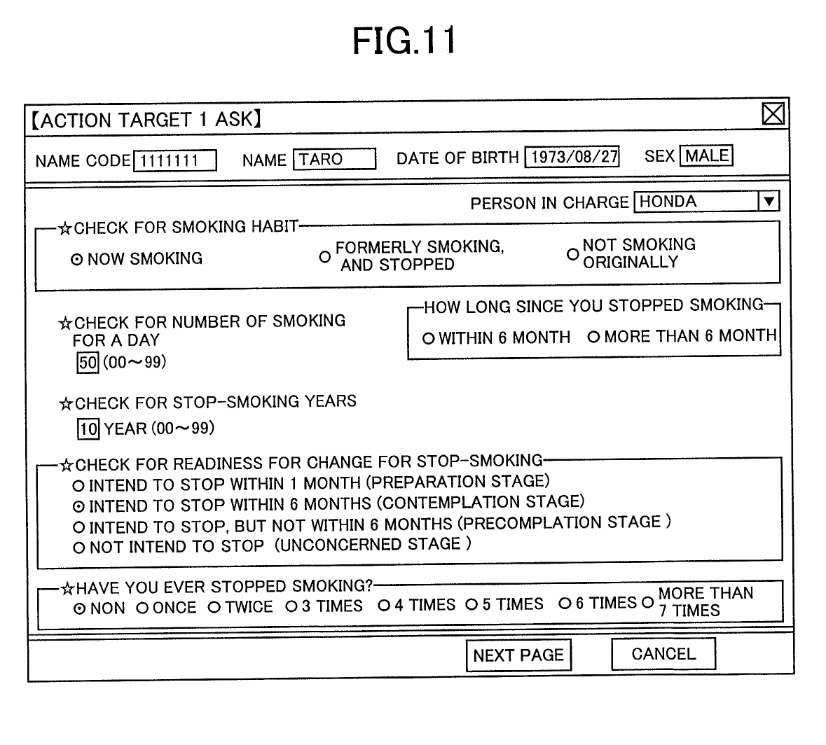

First, smoking habit of the client is checked by using the health question data and the like obtained by medical examination in step 11. When the client does not have the smoking habit, the client is excluded from targets for improving smoking habit. When the client has the smoking habit, the level of readiness for change for stopping smoking is checked in step 12 according to a screen shown in FIG. 11.

Next, experience of stopping smoking (step 13), the time period of stopping smoking (step 14), occasion of starting smoking (step 15) are checked. Then, the reason why the client can not stop smoking is checked when the level of readiness for change is in the contemplation stage, the precontemplation stage or the unconcerned stage in step 16. When the level of readiness for change is in the preparation stage, nicotine dependence and reason for stop-smoking are checked in steps 17 and 18.

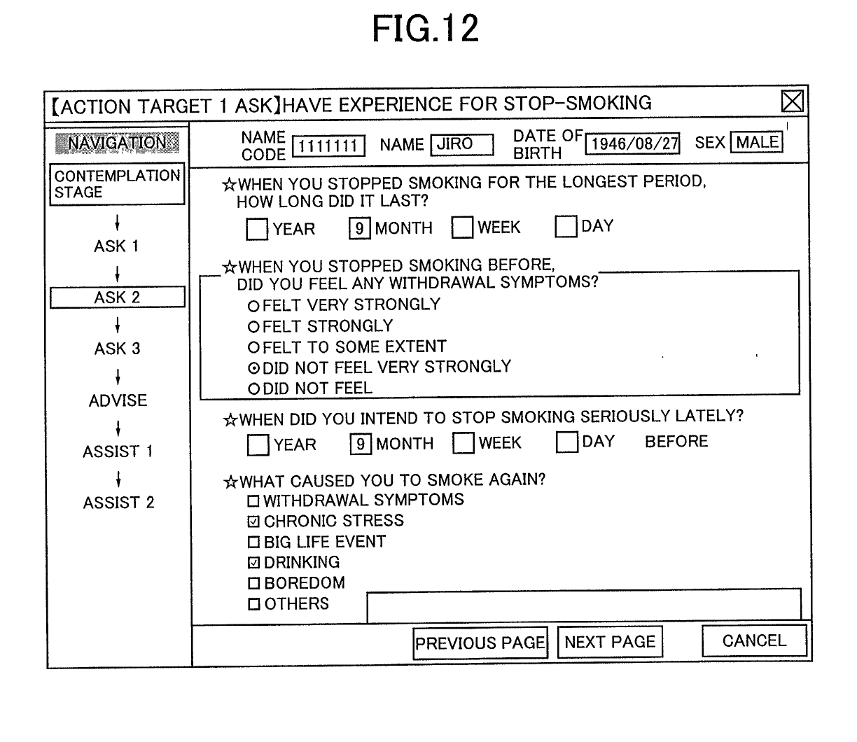

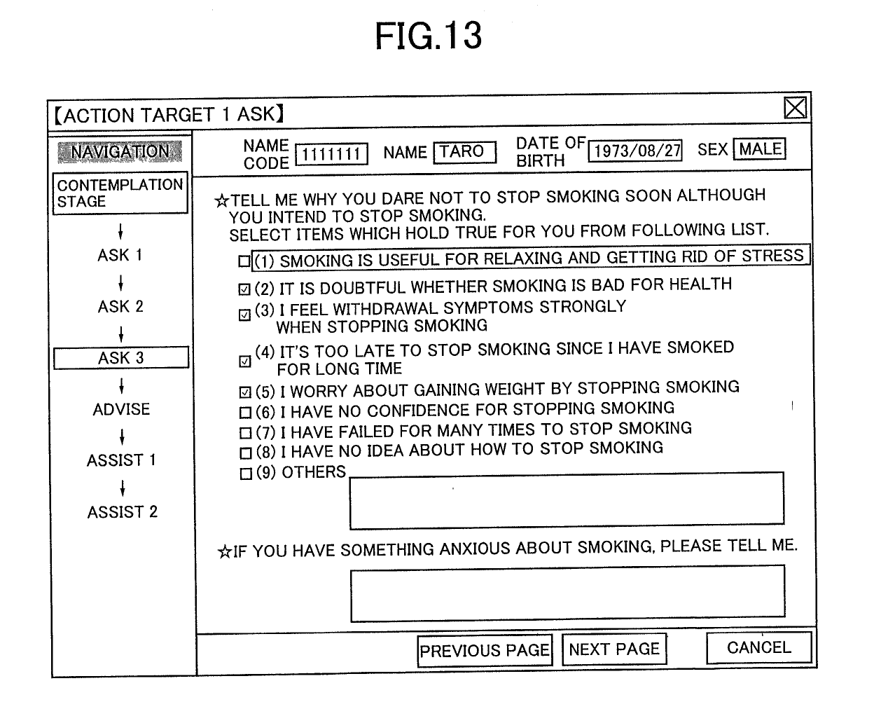

Taking the contemplation stage as an example, the time period of stopping smoking and the occasion of starting smoking are asked to the client according to the screen shown in FIG. 12. The reason why the client can not stop smoking is asked according to the screen shown in FIG. 13. As shown in the left side section in FIG. 13, stages of the questions asked to the client are displayed so that the health promotion practitioner can grasp the present situation.

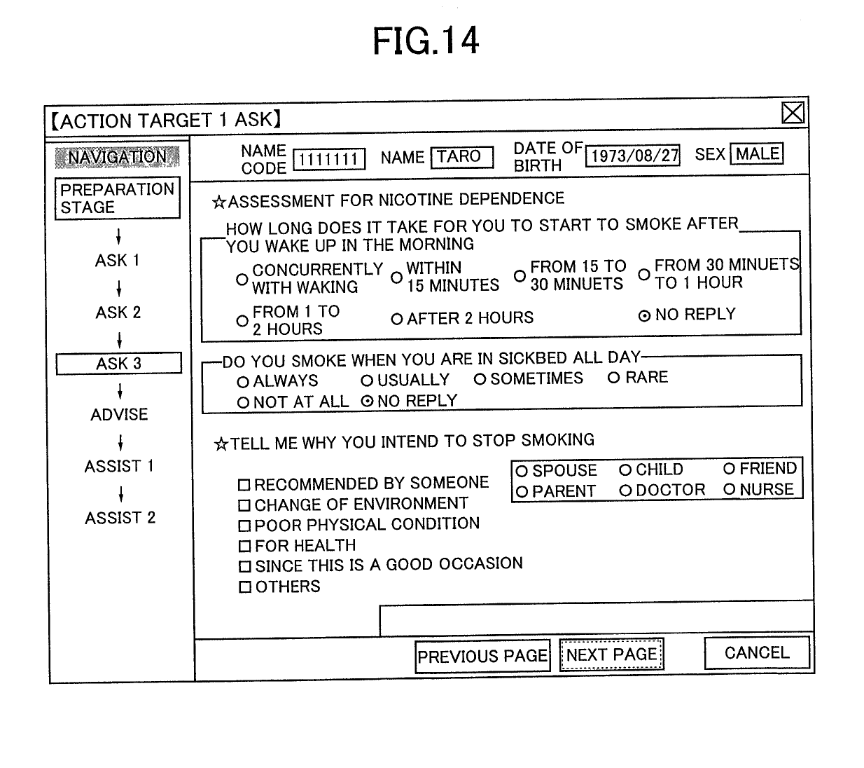

In the preparation stage, nicotine dependence can be checked according to the screen shown in FIG. 14.

The above-mentioned screens are interactive screens. The health promotion schedule for each client is prepared from data entered in this server according to the screens. Detailed description of the health promotion schedule will be given later.

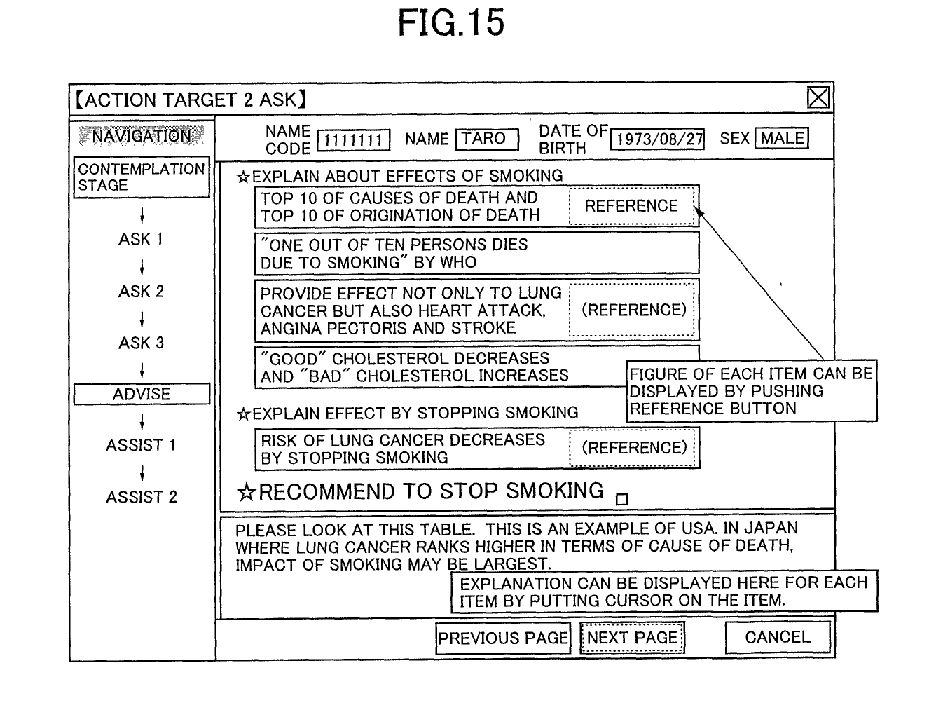

Next, for the contemplation stage, the precontemplation stage or the unconcerned stage, a screen which describes effects of smoking and stopping smoking is displayed in step 19. Then, the health promotion practitioner recommends stopping smoking to the client in step 20. A screen example at this time is shown in FIG. 15. As shown in FIG. 15, a reference screen can be displayed for each item by pushing a reference button. In addition, an explanation can be displayed for each item by putting the cursor on the item.

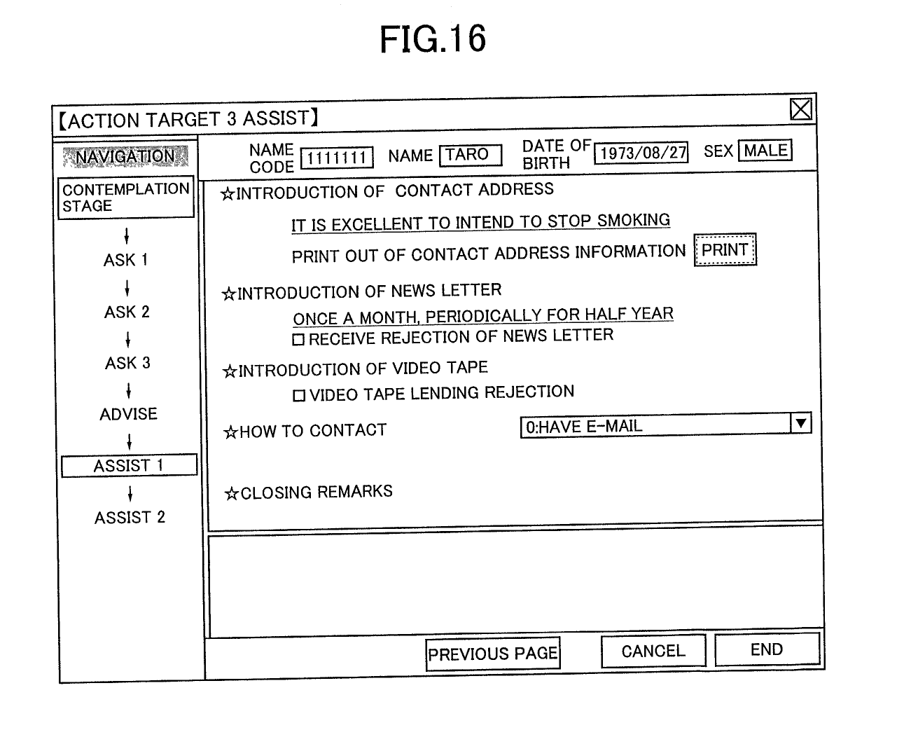

Then, a screen for praising the client for planning stopping smoking and for introducing news letters is displayed in step 21. An example of the screen is shown in FIG. 16.

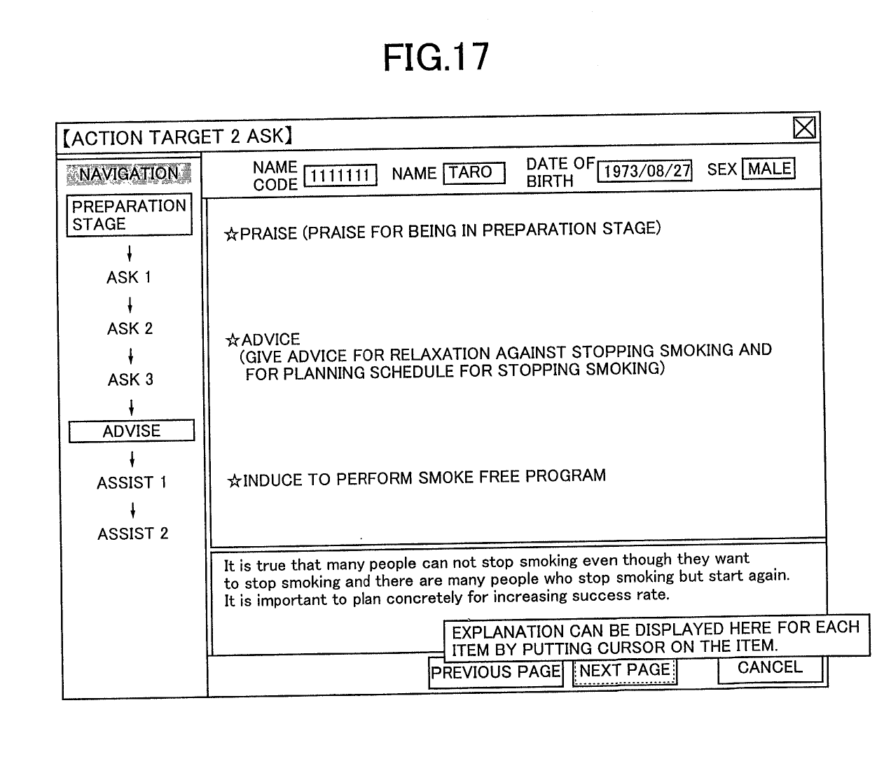

In the preparation stage, a screen for giving advice as shown in FIG. 17 is displayed in step 22. Then, the health promotion practitioner praises the client for preparing stop of smoking and gives advice for relaxation against stopping smoking and for planning schedule for stopping smoking, and induces the client to perform a smoke free program.

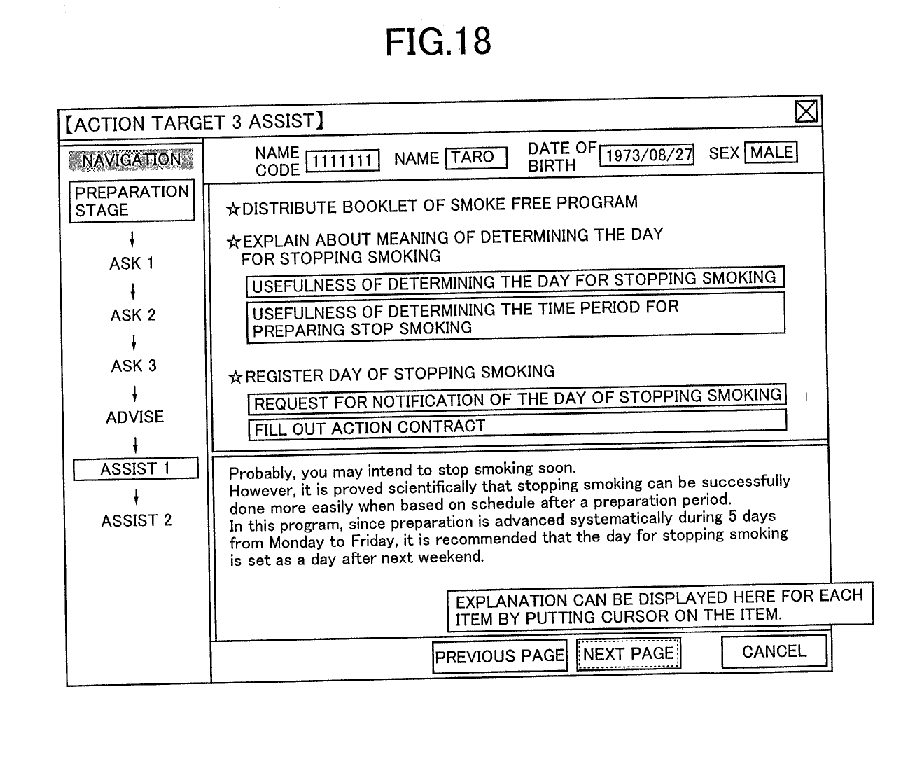

Next, a screen shown in FIG. 18 is shown in step 23. Then, description of usefulness of determining the day for stopping smoking and usefulness of determining the time period for preparing stop smoking is given, and an action contract is filled out.

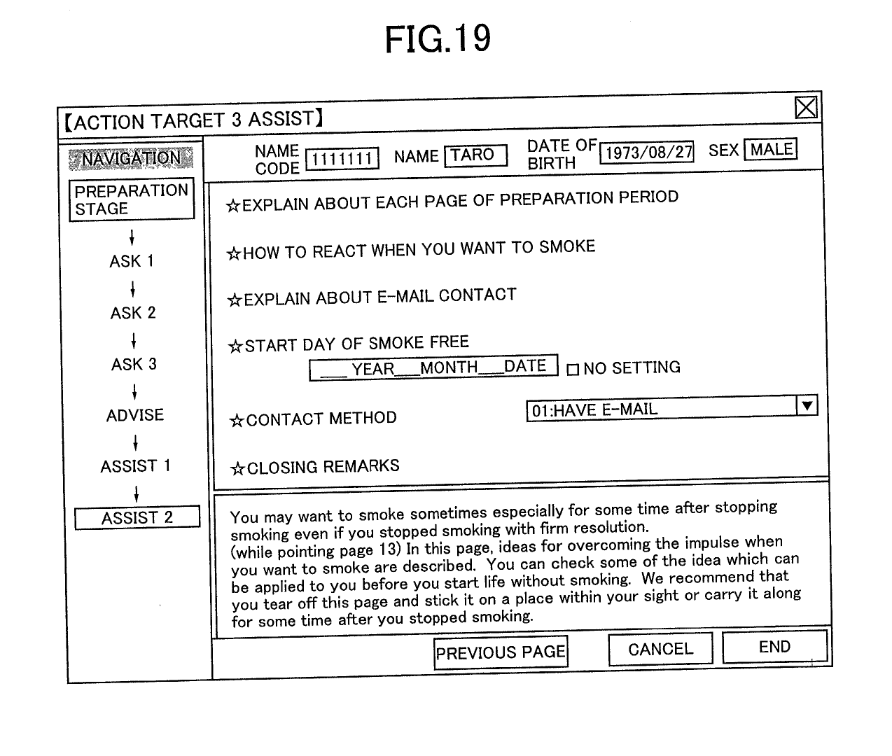

Next, a screen shown in FIG. 19 is displayed in step 24. At this time, the time period of preparation and how to react when the client wants to smoke are described, and the starting day is set.

According to the navigation function described so far, even when the health promotion practitioner does not have much experience, the health promotion practitioner can give descriptions and can perform health promotion properly for the client.

(Generating Schedule)

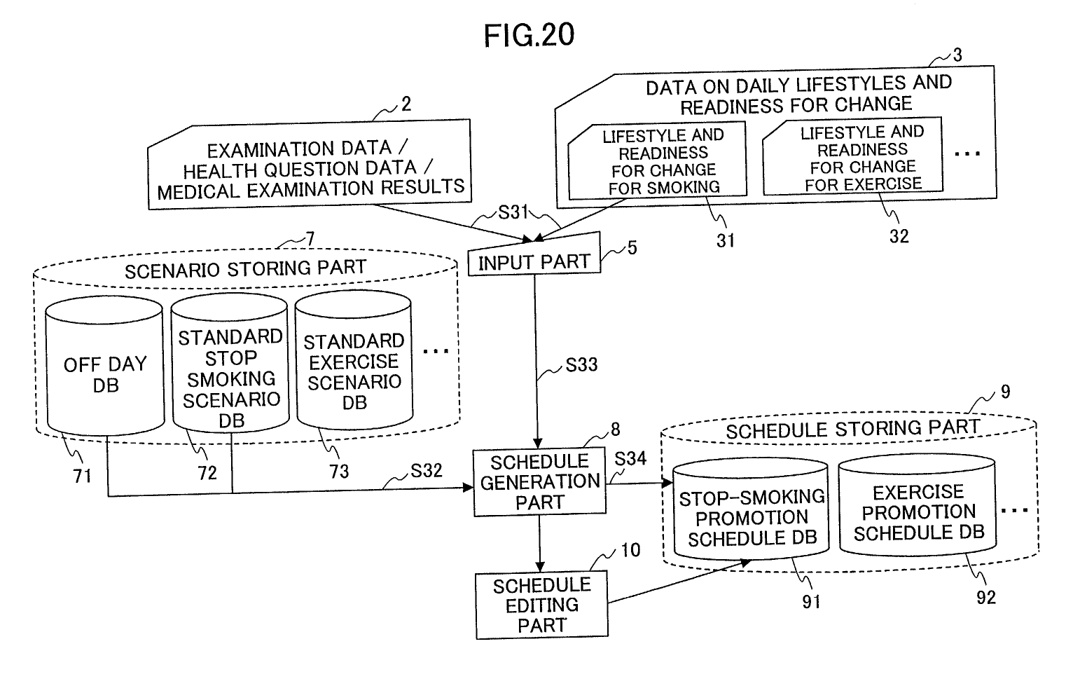

Next, the function of the schedule generation part 8 which generates the health promotion schedule for each client will be described with reference to a flowchart shown in FIG. 20.

When the examination data/health question data/medical examination results 2 obtained in medical examination and the data 3 on daily lifestyles and readiness for change obtained by the health promotion interview are input from the input part 5 in step 31, each scenario which is prepared and managed is called from the scenario storing part 7 in step 32. Then, the health promotion schedule is generated for each client in step 33 and the schedule is stored in the schedule storing part 9 in step 34.

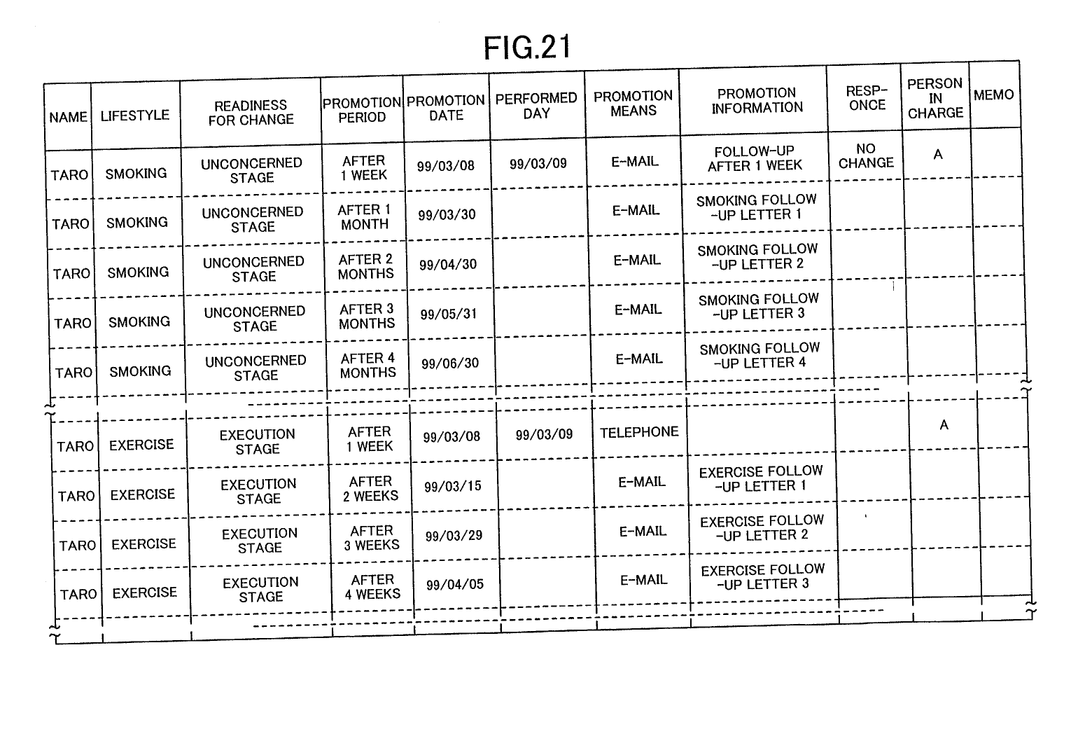

An example of schedule data stored in the schedule storing part 9 is shown in FIG. 21. The schedule data shown in FIG. 21 is generated from data shown in FIG. 9 and the scenario shown in FIG. 4.

That is, the health promotion schedule for each client is generated on the basis of the scenario managed in the scenario storing part by using the data 3 on daily lifestyles and readiness for change. A plurality of health promotion schedules can be generated at the same time.

For example, when data on smoking and exercise as daily lifestyles is input, health promotion schedules for smoking and exercise are generated simultaneously from each scenario of smoking and exercise stored in the scenario storing part 7. The health promotion schedules are input to the schedule storing part 8.

In addition, for example, when data which indicates that kenko Taro is in the unconcerned stage for smoking is collected as a result of an interview, the schedule shown in FIG. 21 is generated from the scenario shown in FIG. 4. In addition, according to data of “the reason why the client can not stop smoking” obtained at the time of the interview, contents and order of stop-smoking follow letters are decided.

According to this embodiment, when generating the health promotion schedule, it is possible that the scheduled promotion date can be shifted automatically according to settings of off days such as Saturday and Sunday, and national holidays in the scenario preparation part 6.

For example, when an health promotion action is set to be performed a month (30 days) from now in the scenario, if the date a month (30 days) from now is Sunday, the health promotion action is shifted to the following day according to the settings of off days.

In addition, the schedule can be added, deleted and changed according to necessity of each client by the schedule editing part 10.

(Schedule Unfolding, Follow-Up Health Promotion)

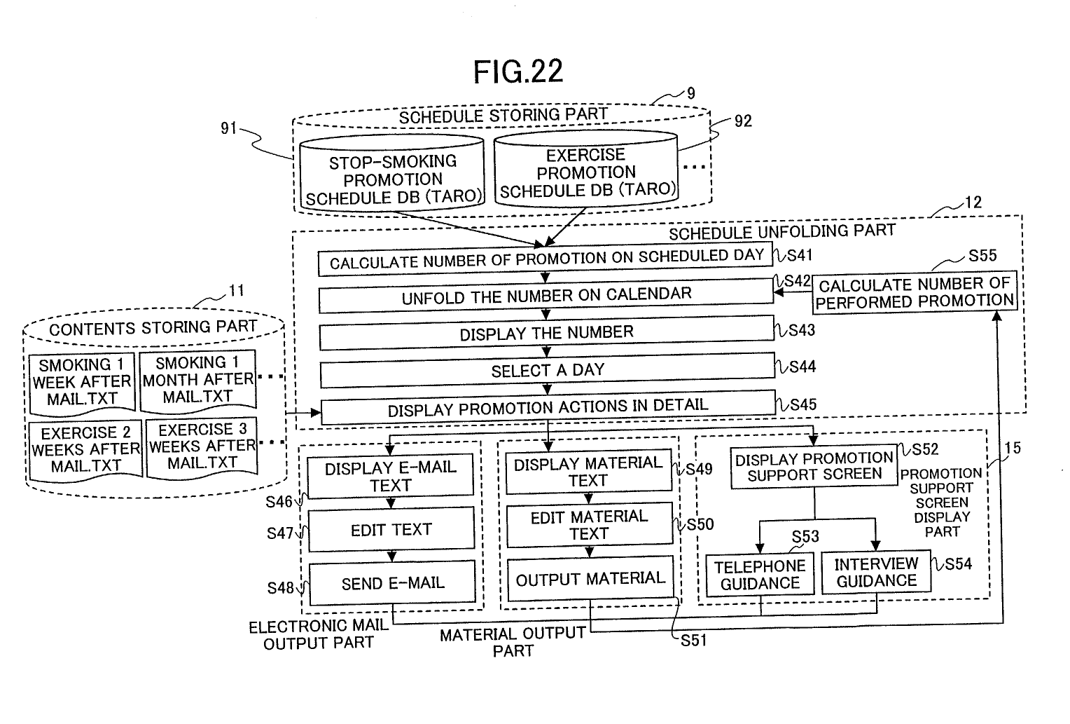

FIG. 22 shows a process flowchart from schedule unfolding to electronic male sending, material sending and support screen displaying.

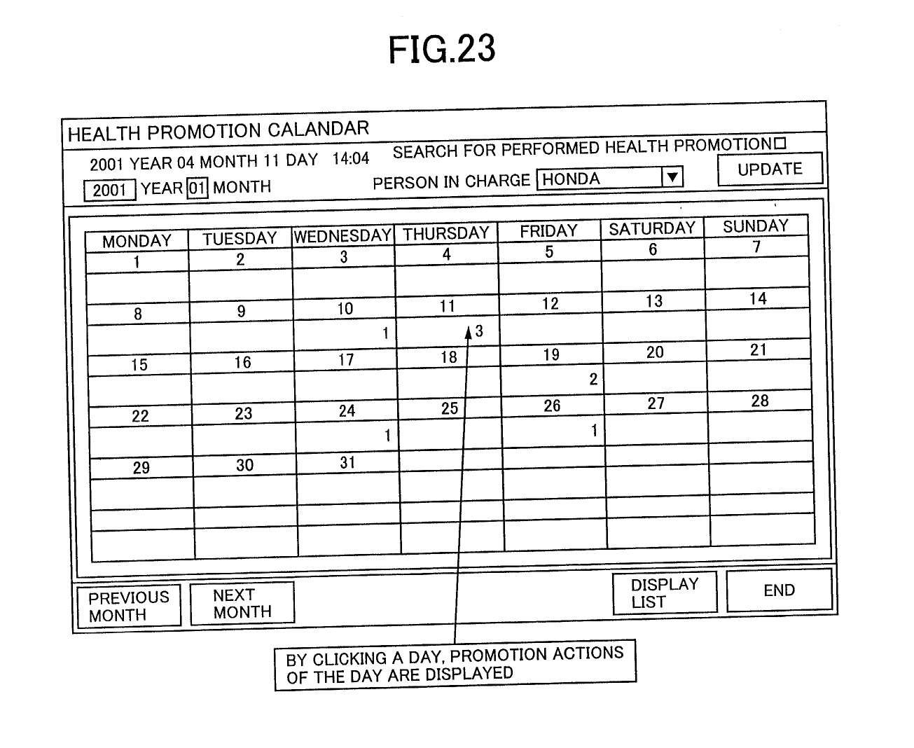

The health promotion schedule for each client stored in the schedule storing part 9 is unfolded on a calendar by the schedule unfolding part 12. On the calendar, the number of health promotion actions to be performed is displayed for each day in steps 41, 42 and 43. An example of the screen is shown in FIG. 23. The health promotion practitioner (for example, a public health nurse) performs health promotion by referring to this screen. The number of health promotion actions to be performed is decreased by the number of the health promotion actions which have been performed.

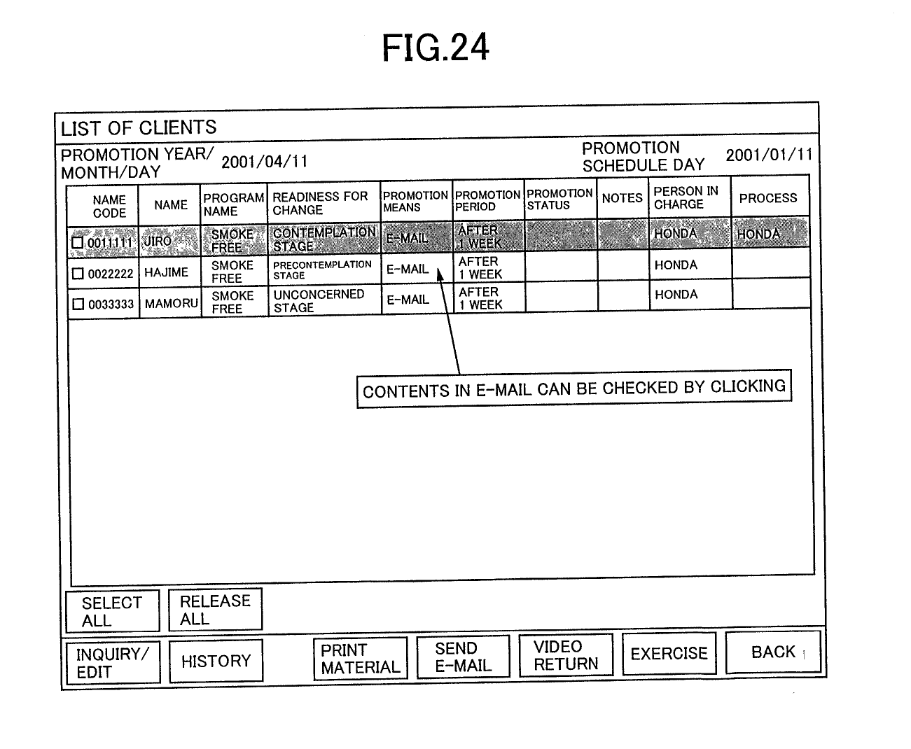

When a day displayed on the calendar is selected, health promotion details of the selected day are displayed in steps 44 and 45. An example of the screen is shown in FIG. 24.

When the health promotion means is the electronic mail, characters managed in the contents storing part 11 are displayed and can be sent as an electronic mail from the electronic mail output part 13 to the client in steps 46-48. When the health promotion means is through the mail, materials for each client managed in the contents storing part 11 can be output from the material output part 14 in steps 49-51.

The contents storing part 11 stores the materials and texts to be sent as the electronic mail as files. The files are read and used for health promotion when the scheduled health promotion is performed.

Texts stored in the contents storing part 11 can be edited on the display screen and the edited text can be sent by the electronic mail or output as the material.

The health promotion support screen display part 15 includes a navigation function like the interview support screen display part 4. According to the navigation function, telephone health promotion screens and interview health promotion screens adapted to a client are displayed according to responses of the client in steps 52-54.

Health promotion information processed by the electronic mail output part 13, the material output part 14 or the health promotion support screen display part 15 is stored in the schedule storing part 9 as history information. The number of health promotion actions are counted by the schedule unfolding part 12 and the number in which the number of health promotion actions which have been performed is subtracted is displayed on the calendar in step 55.

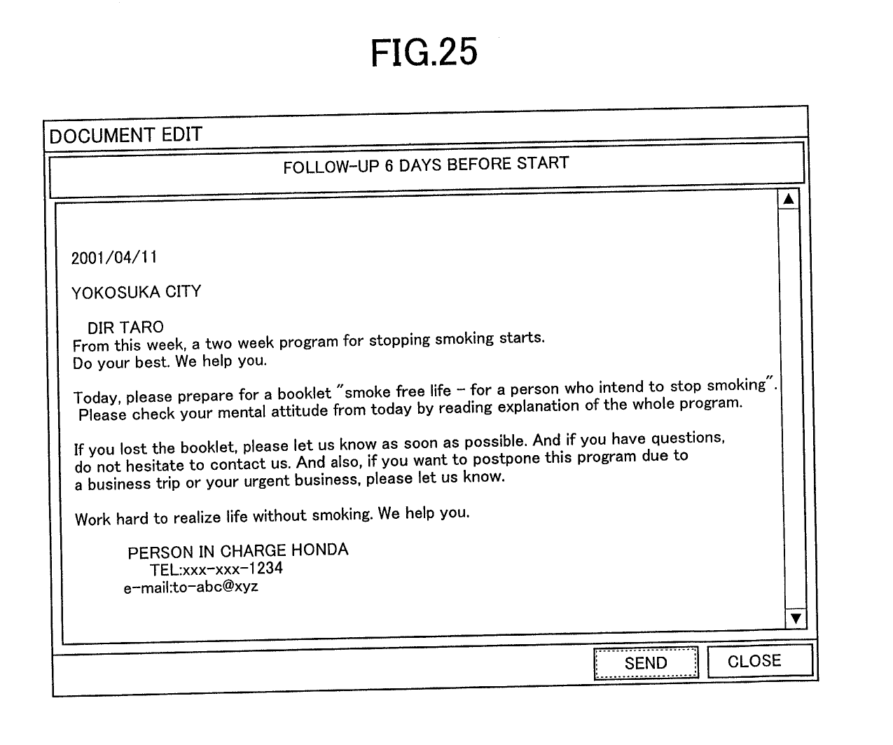

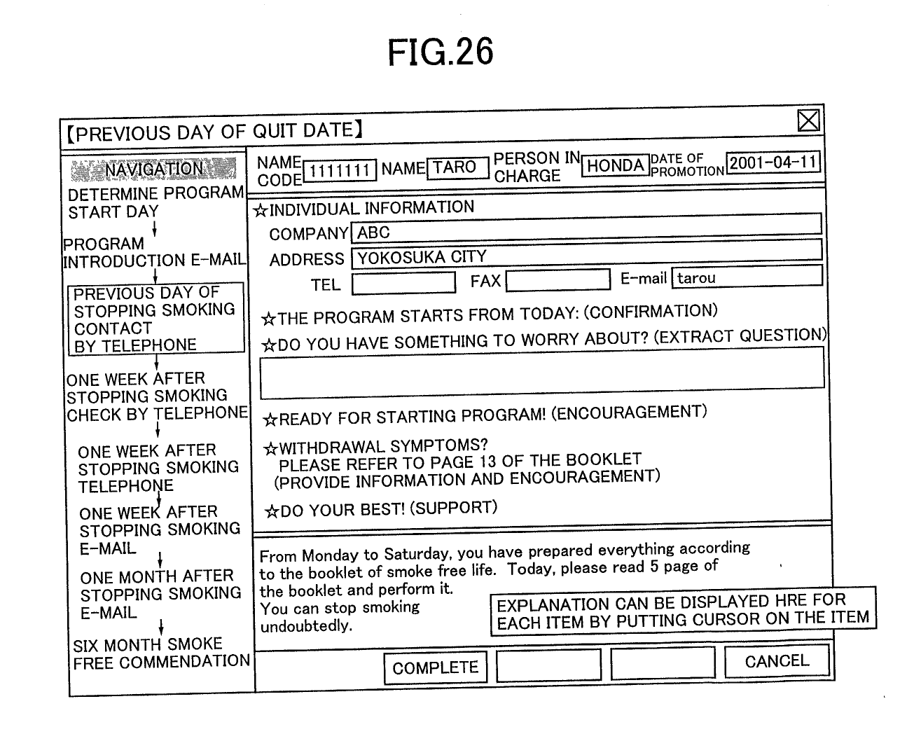

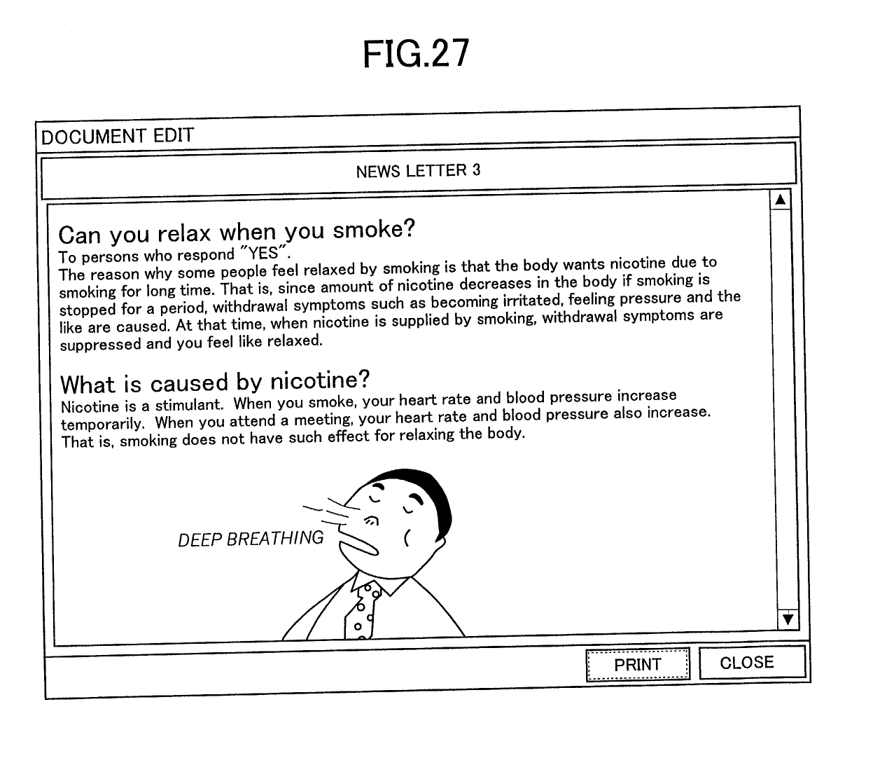

FIG. 25 shows an example of contents of the electronic mail used for follow-up health promotion. FIG. 26 shows an example of telephone health promotion screen . In FIG. 26, summaries of telephone health promotion are displayed on the left side section so that the health promotion practitioner can perform telephone health promotion easily by referring to these summaries. FIG. 27 shows an example of a news letter.

As described above, according to the present invention, the health promotion schedule for clients is generated by using data obtained by the health promotion interview, which is different from a conventional system which temporarily outputs points for improving lifestyles based on medical examination. In addition, according to the present invention, performed health promotion actions are stored as histories. Therefore, improving lifestyles can be supported continuously according to the schedule.

Conventionally, a big difference is caused among health promotion methods according to discretion of health promotion practitioners when the health promotion practitioners perform health promotion for clients. However, according to the present invention, since health promotion information is standardized and managed as the scenario beforehand, health promotion performed by the promotion practitioners can be uniformed so that efficient and proper follow-up promotion practitioner can be performed.

Although improvement of lifestyles (exercise, dietary habits, smoking, stress and the like) is described in this embodiment, the present invention can be also applied to diseases such as hypertension, hyperlipemia and the like.

The present invention is not limited to the specifically disclosed embodiments, and variations and modifications may be made without departing from the scope of the invention.

What is claimed is:

1. A health promotion practitioner support apparatus used for supporting health promotion for preventing diseases caused by lifestyles and for promoting and maintaining health, comprising:
a part storing scenarios which includes health promotion information and health promotion timing for each of levels of readiness for change;
a part obtaining data on lifestyles and said level of readiness for change of a client;
a part preparing a health promotion schedule of said client from said scenario and said data, and outputting said health promotion schedule; and
a part outputting health promotion information for said client according to operation to said health promotion schedule.

2. The health promotion practitioner support apparatus as claimed in claim 1, said part obtaining data comprising:
a part outputting information used for interviewing said client; and
a part receiving responses of said client.

3. The health promotion practitioner support apparatus as claimed in claim 2, said part outputting information used for interviewing said client comprising:
a part outputting question information for checking said level of readiness for change; and
a part determining said level of readiness for change according to a response to said question information and determining information to be output hereafter according to said level of readiness for change;
wherein said health promotion practitioner support apparatus determines said health promotion information according to responses of said client.

4. The health promotion practitioner support apparatus as claimed in claim 1, wherein said levels of readiness for change include an unconcerned stage, a precontemplation stage, a contemplation stage and a preparation stage.

5. The health promotion practitioner support apparatus as claimed in claim 1, wherein:
said health promotion schedule is displayed as a screen of a calendar format on a display part of said health promotion practitioner support apparatus or on a terminal which can access said health promotion practitioner support apparatus; and
a number of clients is displayed in each day of the calendar format if said clients should receive health promotion on said day, and health promotion details are displayed for each of said clients by selecting said day.

6. The health promotion practitioner support apparatus as claimed in claim 5, wherein data for forming said health promotion schedule includes histories of provided health promotion.

7. The health promotion practitioner support apparatus as claimed in claim 1, further comprising:
a part storing plurality of kinds of health promotion information, said plurality of kinds of health promotion information including interview health promotion information, telephone health promotion information, and documents to be sent physically or by electronic mail; and
wherein said part outputting health promotion information outputs said health promotion information by means suitable for one of said kinds of health promotion information.

8. The health promotion practitioner support apparatus as claimed in claim 1, further comprising:
a part obtaining results of medical examination; and
a part selecting clients for preventing a specific disease by using said results.

9. A computer readable medium storing program code for causing a computer to perform processes used for supporting health promotion for preventing diseases caused by lifestyles and for promoting and maintaining health, said computer readable medium comprising:
program code means for obtaining data on lifestyles and a level of readiness for change of a client;
program code means for obtaining a scenario which includes health promotion information and health promotion timing for each of levels of readiness for change;
program code means for preparing a health promotion schedule of said client from said scenario and said data, and outputting said health promotion schedule; and
program code means for outputting health promotion information for said client according to operation to said health promotion schedule.

10. The computer readable medium as claimed in claim 9, said program code means for obtaining data comprising:
program code means for outputting information used for interviewing said client; and
program code means for receiving responses of said client.

11. The computer readable medium as claimed in claim 10, said program code means for outputting information used for interviewing said client comprising:
program code means for outputting question information for checking said level of readiness for change; and
program code means for determining said level of readiness for change according to a response to said question information and determining information to be output hereafter according to said level of readiness for change;
wherein said computer determines said health promotion information according to responses of said client.

12. The computer readable medium as claimed in claim 9, wherein said levels of readiness for change include an unconcerned stage, a precontemplation stage, a contemplation stage and a preparation stage.

13. The computer readable medium as claimed in claim 9, wherein:
said health promotion schedule is displayed as a screen of a calendar format on a display part of said computer or on a terminal which can access said computer; and
a number of clients is displayed in each day of the calendar format if said clients should receive health promotion on said day, and health promotion details are displayed for each of said clients by selecting said day.

14. The computer readable medium as claimed in claim 13, wherein data for forming said health promotion schedule includes histories of provided health promotion.

15. The computer readable medium as claimed in claim 9, further comprising:
program code means for obtaining one of a plurality of kinds of health promotion information, said plurality of kinds of health promotion information including interview health promotion information, telephone health promotion information, and documents to be sent physically or by electronic mail; and
wherein said health promotion information is output by means suitable for one of said kinds of health promotion information.

16. The computer readable medium as claimed in claim 9, further comprising:
program code means for obtaining results of medical examination; and
program code means for selecting clients for preventing a specific disease by using said results.

17. A method of supporting health promotion for preventing diseases caused by lifestyles and for promoting and maintaining health by using a health promotion practitioner support apparatus, said method comprising the steps of:
obtaining data on lifestyles and a level of readiness for change of a client;
obtaining a scenario which includes health promotion information and health promotion timing for each of levels of readiness for change;
preparing a health promotion schedule of said client from said scenario and said data, and outputting said health promotion schedule; and
outputting health promotion information for said client according to operation to said health promotion schedule.
